(19) United States
(12) Patent Application Publication
(10) Pub. No.: US 2026/0251166 A1
(43) Pub. Date: Aug. 27, 2026

(54) ANGLE ASSEMBLY APPARATUS

(71) Applicant: OSI CO.,LTD., Busan (KR)

(72) Inventors: Yongkoo LEE, Busan (KR); Jeongho LEE, Seoul (KR)

(21) Appl. No.: 18/578,393

(22) PCT Filed: Mar. 24, 2022
(86) PCT No.: PCT/KR2022/004104

§ 371 Date: Jan. 11, 2024

(30) Foreign Application Priority Data
Jan. 24, 2022 (KR) 10-2022-0010244
Mar. 4, 2022 (KR) 10-2022-0028270

(51) Int. Cl. F16B 5/02; F16B 35/04

(52) U.S. Cl. CPC F16B 5/02; F16B 35/048

(57) ABSTRACT

Angle assembly system is disclosed. This embodiment facilitates the stable assembly of multiple angles using coupling members, enhancing load-bearing capacity, resistance to torsional stress, and vibration damping concurrently.

### TECHNICAL FIELD

The present invention relates to an angle for supporting heavy objects such as pipes, cable trays, and air conditioning ducts, and more particularly, to an angle assembly system.

### BACKGROUND ART

In onshore and shipbuilding industries, an angle assembly system utilizing multiple angles is commonly used for supporting heavy loads. The angle assembly system is assembled by welding or bolting together the angles of a predetermined thickness after cutting them to match the design drawings.

The conventional angle assembly system, especially when involving welding, poses potential safety risks such as burns, fires, and gas explosions due to the use of welding torches, along with workspace constraints, necessitating constant attention from workers regarding the arrangement and hazards associated with the welding equipment.

Additionally, a drawback arises when the angle assembly system, following the completion of welding operations, encounters challenges in promptly addressing the need for rework due to changes in design or unforeseen modifications in the field.

Constructing the angle assembly system through bolt and nut fastening offers the advantage of ease of reassembly for workers after the fastening operation, yet it introduces drawbacks concerning accuracy and robustness.

Therefore, there is a need for improvement in the angle assembly system to allow workers to securely fasten or release it in a safe manner.

### DISCLOSURE

### Technical Problem

Embodiment of the present invention aims to provide an angle assembly system that is capable of stably supporting heavy loads, allowing easy disassembly and reassembly for workers in case of on-site modifications, and reducing vibrations and impacts from the outside.

### Technical Solution

An angle assembly system according to the first embodiment includes a first angle including a first coupling portion formed on the inner side of a first insertion hole arranged along the longitudinal direction, a second angle including a second coupling portion formed on the inner side of a second insertion hole arranged along the longitudinal direction in a surface-contacted state to one end or an arbitrary position of the first angle, a coupling member installed on the first and second angles in a state of being coupled to the first and second coupling portions, and a support member coupled in the axial direction of the coupling member.

The coupling member includes a head portion formed with a predetermined diameter, a coupling tooth-shaped portion protruding from the underside of the head portion to have a predetermined thickness for engagement coupling with the first coupling portion or the second coupling portion, and a shaft portion extending outwardly from the coupling tooth-shaped portion with a predetermined length and having threads formed on the outer side in the axial direction.

The head portion includes a magnet in the inner side thereof.

The coupling tooth-shaped-portion includes a first coupling tooth-shaped-portion formed in the horizontal direction and a second coupling tooth-shaped-portion formed in the vertical direction.

The coupling tooth-shaped portion is formed in one of shapes selected from among triangular, semicircular, square, or polygonal shapes.

The coupling tooth-shaped-portion extends in in both horizontal and vertical directions to a length corresponding to the width of the first and second coupling portions.

The first coupling portion includes a first insertion hole extending for a predetermined length in the entire inner regions facing each other, and the second coupling portion includes a second insertion hole extending for a predetermined length in the entire inner regions facing each other, the first coupling portion having a first tooth-shaped portion for engagement coupling with the coupling member, and the second coupling portion having a second tooth-shaped portion for engagement coupling with the coupling member.

The first angle includes first insertion holes penetrating each of one and the other flanges formed by being bent at least once along a first bending portion, and the second angle includes second insertion holes penetrating each of one and the other flanges formed by being bent at least once along a second bending portion.

A reinforcing rib is installed on one or both of the first and second angles at predetermined intervals along the inner length direction.

The reinforcing rib is inserted into insertion slots formed on the inner sides of the first and second angles and fixed through welding.

A main rib is arranged on one or both of the first and second angles at predetermined intervals along the inner length direction and coupled with the coupling member in different directions.

The main rib includes a first rib designed to adhere to either or both of the bent inner surfaces of the first angle or the second angle and having a first rib coupling portion formed to engage with one coupling member inserted, a second rib formed to adhere to the other bent inner surface of the first or second angles and having a second rib coupling portion formed to engage with another coupling member inserted; and a third rib connecting the first and second ribs to each other.

The third rib is bent at a 90-degree angle with respect to the first and second ribs to support the load.

The first rib coupling portion includes a first rib coupling tooth-shaped portion formed on the inner side for engagement coupling with one coupling member, and the second rib coupling portion includes a second rib coupling tooth-shaped portion formed on the inner side for engagement coupling with another coupling member.

An angle assembly system according to the second embodiment includes a first angle comprising a first coupling portion formed on the inner side of a first insertion hole arranged along the longitudinal direction, a second angle comprising a second coupling portion formed on the inner side of a second insertion hole arranged along the longitudinal direction in a surface-contacted state to one end or an arbitrary position of the first angle, a coupling member installed on the first and second angles in a state of being coupled to the first and second coupling portions, a support member coupled in the axial direction of the coupling member, a main rib arranged on one or both of the first and second angles at predetermined intervals along the inner length direction and coupled with the coupling member in different directions, and a damping member inserted into the coupling member and in surface-contact with one or both of the first and second angles to absorb impact.

The main rib includes a first rib designed to adhere to one of the bent inner surfaces of the first angle or the second angle and has a first rib coupling portion formed to engage with a coupling member inserted, a second rib designed to adhere to the other bent inner surface of the first angle or the second angle and has a second rib coupling portion formed to engage with another coupling member inserted; and a third rib connecting the first and second ribs to each other.

The first rib coupling portion includes a first rib coupling tooth-shaped portion formed on the inner side for engagement coupling with one coupling member, and the second rib coupling portion includes a second rib coupling tooth-shaped portion formed on the inner side for engagement coupling with another coupling member.

The damping member includes a first damper surface-contacting the underside of a head portion formed on the coupling member and a second damper integrally formed with the first damper and surface-contacting one or both of the first and second angles.

The first damper and the second damper have different densities.

The support member includes a nut head formed with a predetermined diameter and a nut body integrally formed with the nut head hand having a nut hole formed to be inserted in the axial direction of the coupling member.

The support member includes an auxiliary damper formed on the front side of the nut head and surface-contacting the corresponding surface after being coupled with the coupling member 300.

### Advantageous Effects

The embodiments are advantageous in terms of maintaining structurally stable support and increasing the maximum allowable load of assembled first and second angles by altering the structural configuration of the coupling member and the first and second angles without increasing the thickness of the first and second angles.

The embodiments are advantageous in terms of allowing the coupling member to establish a tooth-shaped coupling between the first and second angles to enhance coupling strength and stability and facilitate disassembly and reassembly in cases requiring modifications, leading to the improvement of worker performance and operational efficiency.

The embodiments are advantageous in terms of minimizing vibrations caused by external forces or vibrations transmitted to the first and second angles.

### Description of Drawings

FIG. 1 is a front view of an angle assembly system according to an embodiment;

FIG. 2 is an enlarged view illustrating a portion where a coupling member is attached according to an embodiment;

FIG. 3 is a perspective view illustrating the state where the first and second angles are coupled via a coupling member according to an embodiment;

FIG. 4 is a cross-sectional view of FIG. 3;

FIG. 5 is a perspective view of a coupling member according to an embodiment;

FIG. 6 is a front view of FIG. 5;

FIG. 7 is a perspective view illustrating reinforcing ribs according to an embodiment;

FIG. 8 is a perspective view illustrating the state where the reinforcing ribs of FIG. 7 are installed;

FIG. 9 is a perspective view illustrating the state where reinforcing ribs are installed according to an embodiment;

FIG. 10 is a perspective view illustrating a main rib according to an embodiment;

FIGS. 11 and 12 are perspective views illustrating the state where a main rib is installed according to an embodiment;

FIG. 13 is a cross-sectional view illustrating a damper unit according to an embodiment; and

FIG. 14 is a cross-sectional view illustrating a support member according to an embodiment.

### MODE FOR INVENTION

Advantages and features of this disclosure and methods of accomplishing the same may be understood more readily by reference to the embodiments described with reference to the accompanying drawings. This disclosure can, however, be embodied in many different forms and should not be construed as being limited to the embodiments set forth herein; rather, these exemplary embodiments are provided so that this disclosure will be thorough and complete and will fully convey the concept of the disclosure to those skilled in the art, and this disclosure will only be defined by the appended claims. Throughout the specification, like reference numerals refer to like components.

When a component is described as “connected to” or “coupled to” another component, it can refer to a direct connection or coupling with the other component, or to a case where another component is interposed therebetween. Meanwhile, when a component is referred to as “directly connected to” or “directly coupled to” another component, it indicates that there is no other component interposed therebetween. The expression “and/or” is taken to include each of the mentioned items and any combination of one or more.

The terminology used in this specification is for the purpose of describing embodiments, and is not intended to limit the disclosure. In this specification, the singular form includes the plural form unless otherwise specified in the phrase. The “comprises” and/or “comprising” used in the specification do not preclude the presence or addition of one or more other components, steps, operations, and/or devices.”

Although the terms “first,” “second,” and the like are used for describing various components, these components are not confined by these terms. These terms are merely used for distinguishing one component from the other components.

A description is made of the angle assembly system according to the first embodiment of the present invention with reference to accompanying drawings.

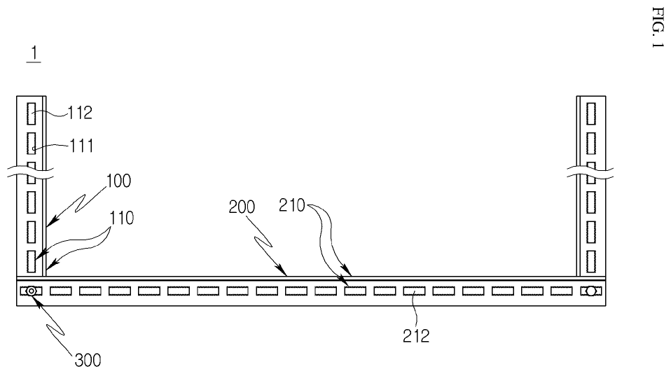

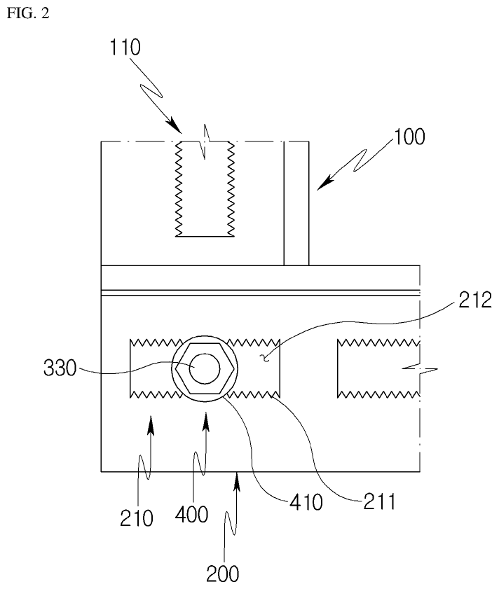

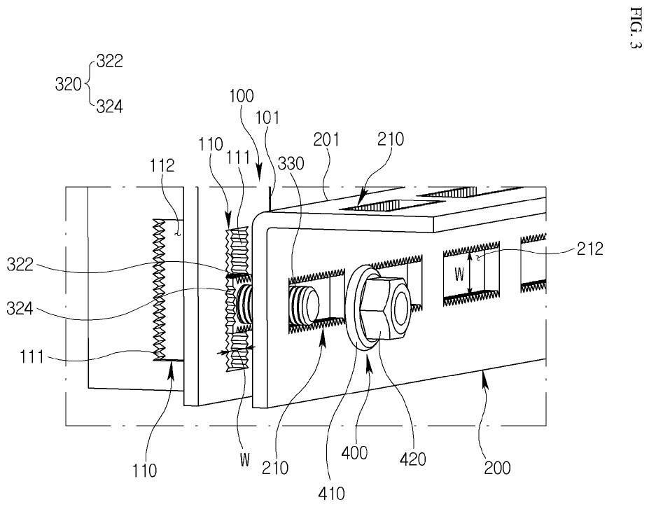

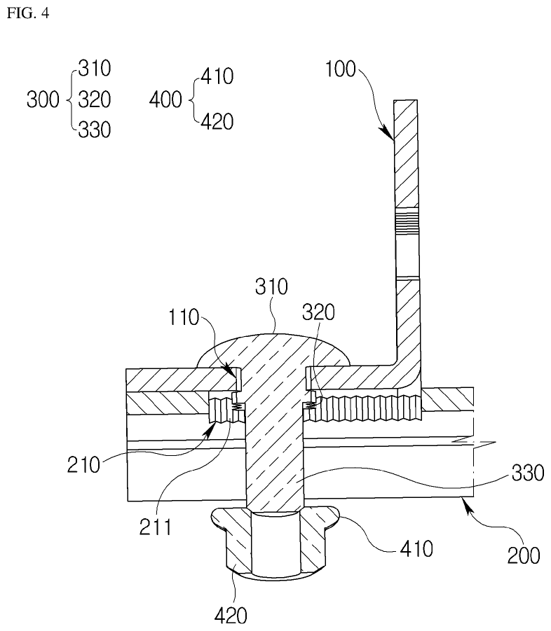

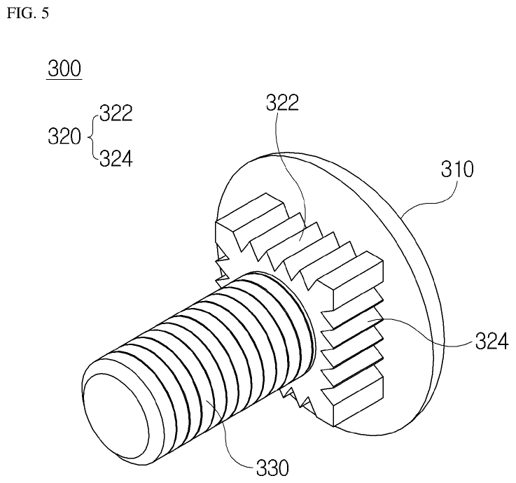

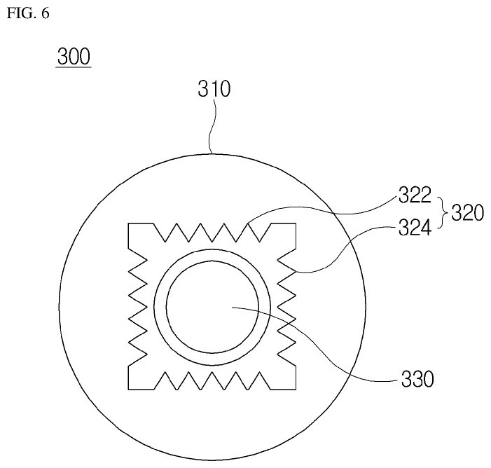

With reference to FIGS. 1 to 6, the angle assembly system 1 according to this embodiment aims to enhance load-bearing performance through structurally stable coupling, prevent distortion and sagging, facilitate assembly and disassembly without compromising robust assembly performance, and ensure safe operations for workers.

To accomplish this, this embodiment is implemented with the inclusion of a first angle 100 having a first coupling portion 110 formed on the inner side of a first insertion hole 112 arranged along the longitudinal direction thereof, a second angle 200 having a second coupling portion 210 formed on the inner side of a second insertion hole 212 arranged along the longitudinal direction thereof in a surface-contacted state to one end or an arbitrary position of the first angle 100, a coupling member 300 installed on the first and second angles 100 and 200 in a state of being coupled to the first and second coupling portions 210 and 220; and a support member 400 coupled in the axial direction of the coupling member 300.

The first angle 100 and the second angle 200 may be made from various materials, including, but not limited to, metal, non-metal, reinforced plastic, or any material that maintains a specified rigidity. However, in this embodiment, the first and second angles 100 and 200 are described as being made of metal, but they may be made of various materials as described above.

For example, the first angle 100 may be arranged vertically, and the second angle 200 may be surface-contacted to one end (e.g., the lower end) or an arbitrary position of the first angle 100 so as to be assembled in a variety of ways, not only in the state shown in the drawing, with each other through the coupling member 300.

In this embodiment, the coupling member 300 not only engages, after being inserted into the first and second angles 100 and 200, with the support member 400 but also establishes engagement coupling with the first coupling portion 110 of the first angle 100 and the second coupling portion 210 of the second angle 200 to increase the allowable load value of the first and second angles 100 and 200 and increase the torsional stress to increase the structural strength.

In particular, the coupling member 300 includes a coupling tooth-shaped portion 320 to be described later for engagement coupling with the first and second angles 100 and 200.

In this embodiment, the engagement coupling is exemplified as tooth engagement, but other forms of coupling are also possible. In addition, engagement coupling means that the coupling member 300 and the first and second coupling portions 110 and 210 are coupled together in a state of being interlocked at multiple positions, rather than simple insertion.

In this embodiment, the first and second angles 100 and 200 are assembled or disassembled through the coupling member 300 and the support member 400, and the first and second angles 100 and 200 and the coupling member 300 are assembled with each other through a tooth engagement method.

In this embodiment, the first angle 100 includes first insertion holes 112 penetrating each of one and the other flanges formed by being bent at least once along a first bending portion 101, and the second angle 200 includes second insertion holes 212 penetrating each of one and the other flanges formed by being bent at least once along a second bending portion 201. The first insertion holes 112 are formed with the same length and width, ensuring stable insertion at any position where the coupling member 300 is inserted.

The second insertion holes 212 are formed with the same length and width, ensuring stable insertion of the coupling member 300 at any position.

In the embodiment, the first angle 100 includes the first coupling portion 110, and the first coupling portion 110 includes the first insertion holes 112 that extends for a predetermined length in the entire inner region facing each other.

The second angle 200 includes the second coupling portion 210, and the second coupling portion 210 includes the second insertion holes 212 that extends for a predetermined length in the entire inner regions facing each other.

For example, the first insertion hole 112 is formed as a slot hole elongated in one direction and having a predetermined width W. The width W is formed to a length corresponding to the horizontal or vertical length of the coupling tooth-shaped portion 320, allowing stable coupling when the coupling member 300 is inserted.

In one example, the width W may be formed to be relatively longer than the horizontal and vertical lengths of the coupling tooth-shaped portion 320.

The first coupling portion 110 has a first tooth-shaped portion 111 formed for engagement coupling with the coupling member 300, and the second coupling portion 210 has a second tooth-shaped portion 211 formed for engagement coupling with the coupling member 300

The first tooth-shaped portion 111 is formed in the same shape as the first coupling tooth-shaped portion 322 or the second coupling tooth-shaped portion 324, ensuring that the coupling member 300 can stably engage with the first tooth-shaped portion 111.

For example, the first tooth-shaped portion 111 is formed in the shape of teeth of which the pitch is 2 mm, allowing for precise assembly by finely adjusting the spacing with the pitch when the coupling member 300 is engaged. In this case, the coupling member 300 may be precisely assembled at the intended position by the designer, enhancing structural coupling strength and stability.

Particularly in this embodiment, when the coupling member 300 is inserted into the first coupling portion 110, forward or backward movement is possible in the insertion direction, but due to the tooth-shaped coupling, lateral (left or right) movement is not possible, ensuring that the coupling state remains stable and is not released even under external impact.

Additionally, the first and second angles 100 and 200 maintain a surface-contacted state with each other even when twisting occurs, ensuring that the initially coupled state is stably maintained and allowing for stable adaptation to stress changes caused by twisting.

The second tooth-shaped portion 211 has the same structure as the first tooth-shaped portion 111 and is formed, for example, in the shape of teeth with a pitch of 2 mm, allowing for precise assembly by finely adjusting the spacing with the pitch when the coupling member 300 is engaged. In this case, the coupling member 300 may be precisely assembled at the intended position by the designer, enhancing structural coupling strength and stability.

The first coupling portion 110 and the second coupling portion 210 have the first tooth-shaped portion and the second tooth-shaped portion 211 formed, respectively, allowing the coupling member 300 to be precisely aligned when assembled with the first and second angles 100 and 200.

The coupling member 300 includes a head portion 310 formed with a predetermined diameter, a coupling tooth-shaped portion 320 protruding from the underside of the head portion 310 to have a predetermined thickness to allow engagement coupling with the first coupling portion 110 or the second coupling portion 210, and a shaft portion 330 extending outwardly from the coupling tooth-shaped portion 320 with a predetermined length and having threads formed on the outer side in the axial direction.

The head portion 310 is formed in a semicircular shape but may be changed to another shape, and a magnet (not shown) may be attached to the inner side to facilitate insertion into the first angle 100.

The magnet is provided to facilitate the easier installation of the coupling member 300 by attaching to the inner side of the first angle 100 facing the head portion 310 by magnetic force when the coupling member 300 is inserted into the first insertion hole 112 of the first angle 100.

The magnet may be formed, for example, in a predetermined size or in a form where a coating layer is formed on the underside of the head portion 310 with a predetermined thickness.

The coupling tooth-shaped portion 320 includes a first coupling tooth-shaped portion 322 formed in the horizontal direction and a second coupling tooth-shaped portion 324 formed in the vertical direction. The coupling tooth-shaped portion 320 is not limited to the form shown in the drawing and may be formed in one of shapes selected from among triangular, semicircular, square, or polygonal shapes.

However, in this embodiment, the first and second coupling tooth-shaped portions 322 and 324 are illustrated as triangular forms, but it is possible to apply different shapes as well.

The first and second coupling tooth-shaped portions 322 and 324 protrude from the underside of the head portion 310 at a predetermined height and are formed in the same shape in the horizontal and vertical directions, allowing easy engagement with the first insertion hole 112 when a work grips the coupling member 300 at any position.

In addition, when the first and second coupling tooth-shaped portions 322 and 324 are formed as shown in the drawing, it facilitates manufacturing and ensures consistent tolerance control, preventing potential issues of the coupling member 300 not properly engaging with the first and second angles 100 and 200 at the work site.

Additionally, the first and second coupling tooth-shaped portions 322 and 324 are extended to the same length in both the horizontal and vertical directions to ensure stable engagement with the first tooth-shaped portion 111 and the second tooth-shaped portion 211.

The coupling tooth-shaped portion 320 is extended in both horizontal and vertical directions to a length corresponding to the width W of the first and second coupling portions 110 and 210, facilitating easy engagement of the coupling member 300 with the first and second coupling portions 110 and 210.

The shaft portion 330 may be integrally formed with the coupling tooth-shaped portion 320, extending to a predetermined length and featuring threads, allowing easy coupling with the support member 400.

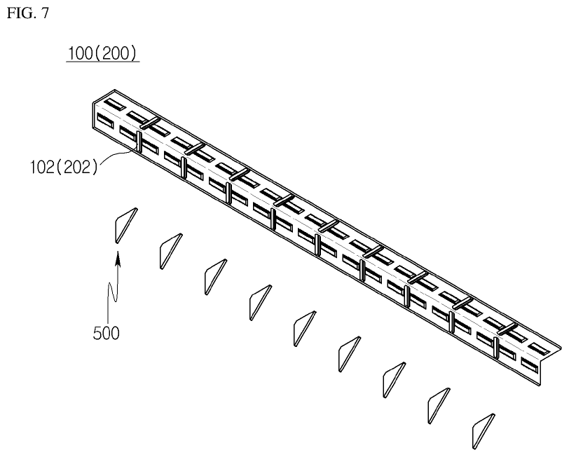

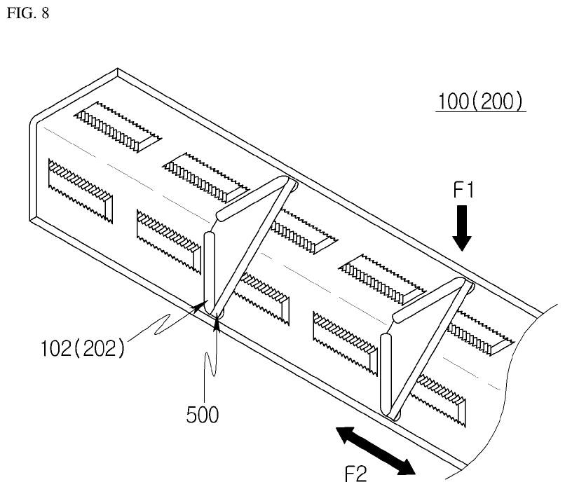

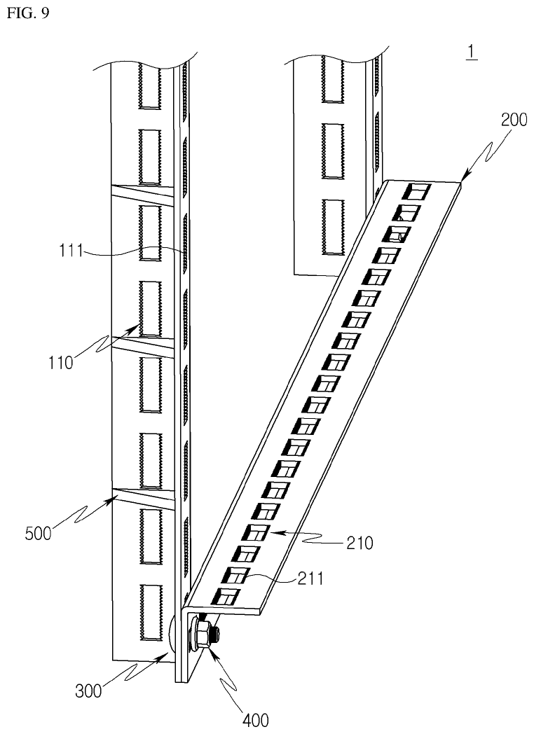

With reference to FIGS. 7 to 9, in this embodiment, one or both of the first and second angles 100 and 200 are provided with reinforcing ribs 500 installed at regular intervals along the inner length direction to address structural rigidity or torsion.

The reinforcing ribs 500 are inserted into insertion slots 102 and 202 formed on the inner sides of the first and second angles 100 and 200, and after insertion into the insertion slots 102 and 202, the reinforcing ribs 500 are fixed in place through welding.

For example, the reinforcing ribs 500 are provided to stably support the stress generated by the inherent load in the first angle 100 or various stresses transmitted from the outside (vertical or horizontal stresses or torsional stresses).

For example, the reinforcing ribs 500 are formed in a triangular plate shape and are first inserted and coupled into the insertion slots 102 and 202 and then installed by welding by a worker.

The reinforcing ribs 500 may be installed at regular intervals to provide stable support at any position on the first angle 100 when subjected to loads or external forces.

For example, the reinforcing ribs 500 installed on the inside of the first angle 100 may support stresses applied in the vertical direction F1 and horizontal direction F2, enhancing the load-bearing capacity of the first angle 100 and minimizing deformation.

In particular, since the reinforcing ribs 500 are formed in a triangular plate shape, stresses applied in the vertical direction F1 may be transmitted downward along the vertical direction and the inclined surfaces, reducing the impact.

Furthermore, stresses applied in the horizontal direction F2 at specific locations on the first angle 100 may be reduced after being transmitted through the reinforcing ribs 500 and the first angle 100, preventing the overall twisting of the first angle 100.

Therefore, even when a certain load is applied to or suspended from the first angle 100 with a heavy weight, potential deformation problems are minimized, leading to enhanced stability.

In this embodiment, the reinforcing ribs 500 are also installed on the inner side of the second angle 200, following the same configuration as the first angle 100, so the detailed description is omitted.

A description is made of the main rib according to this embodiment with reference to accompanying drawings.

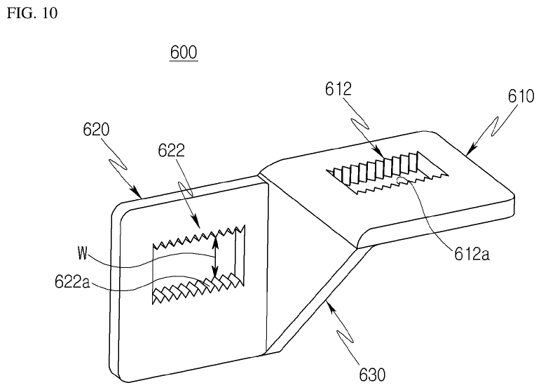

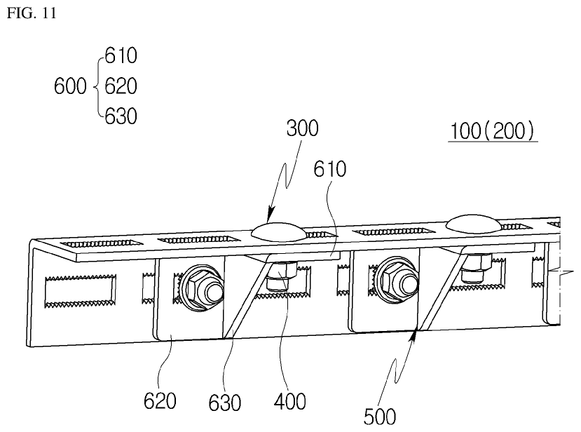

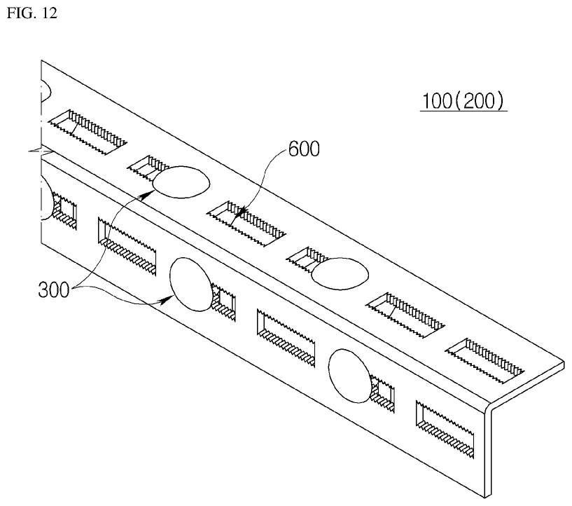

With reference to FIGS. 10 to 12, the main rib 600 according to this embodiment is arranged at regular intervals along the inner length direction of one or both of the first angle 100 or the second angle 200, and coupled with the coupling member 300 in different directions.

The main rib 600, unlike the above-described reinforcing ribs 500, is installed with the connection member 300 so as to be assembled in a state of being individually coupled with the first angle 100 or the second angle 200.

In this case, the structural rigidity of the first angle 100 or the second angle can be increased. This may also improve the load-bearing capacity without increasing the thickness of the first and second angles 100 and 200 and minimize deformation even when heavy loads are applied to the first and second angles 100 and 200.

The main rib 600 includes a first rib 610 designed to adhere to either or both of the bent inner surfaces of the first angle 100 or the second angle 200 and having a first rib coupling portion 612 formed to engage with one coupling member inserted, a second rib 620 designed to adhere to the other bent inner surface of the first angle 100 or the second angle 200 and having a second rib coupling portion 622 formed to engage with another coupling member inserted, and a third rib 630 connecting the first rib 610 and the second rib 620 to each other.

The main rib 600, as shown in the drawing, may be installed at regular intervals or, according to the judgment of the worker at the work site, the number of installations may be freely changed, allowing for easy reinforcement of stress at selectively installed locations where local loads increase.

For example, although the main rib 600 is described as being installed on the second angle 200, it is also possible to install it on the first angle 100.

The first rib 610 is installed via one coupling member 300 after coming into surface contact with the inner upper surface of the second angle 200. The coupling member 300 is vertically coupled from the upper surface to the lower surface of the second angle 200, based on the drawing.

The second rib 620 is installed via one coupling member 300 after being surface-contacted with the inner front face of the second angle 200. The coupling member 300 is attached from the back surface to the front surface of the second angle 200, based on the drawing.

When the worker first couples the first rib 610 with the coupling member 300, the second rib 620 remains facing the second coupling portion 210, allowing for easy assembly by inserting another coupling member 300.

The main rib 600 has a first rib coupling tooth-shaped portion 612a formed on the inner side for engagement coupling with one coupling member at the first rib coupling portion 612 and a second rib coupling tooth-shaped portion 622a formed on the inner side for engagement coupling with another coupling member at the second rib coupling portion 622.

The first rib coupling portion 612 is configured similarly to the first coupling portion 110 and is formed, for example, with a slot hole elongated in one direction, having a predetermined width W. The width W is formed to a length corresponding to the horizontal or vertical length of the coupling tooth-shaped portion 320, allowing stable coupling when the coupling member 300 is inserted.

The first rib coupling tooth-shaped portion 612a is formed, as shown in the drawing, for engagement coupling with the first coupling tooth-shaped portion 322 or the second coupling tooth-shaped portion 324 formed on the coupling member 300.

For example, when the coupling member 300 is inserted into the first rib coupling portion 612 through the second coupling portion 210, it engages with the second tooth-shaped portion 211 formed on the second coupling portion 210 and the first rib coupling shape 612a formed on the first rib coupling portion 612.

In this case, the coupling member 300 is assembled with the second angle 200 and the main rib 600 in a state of not simply being inserted but interlocking the tooth-shaped portions with each other, enhancing the coupling force.

When the worker sequentially assembles the remaining main ribs 600 in the same manner, the second angle 200 has improved load-bearing capacity, torsional stress resistance, and resistance to external forces, leading to enhanced structural rigidity.

According to this embodiment, the third rib 630 is bent at a 90-degree angle relative to the first and second ribs 610 and 620, supporting the load and enhancing the resistance to vertical or horizontal stress transmitted through the second angle 200.

In addition, the consistent arrangement of the main rib 600 on the inner side of the second angle 200 enhances the overall resistance to external forces across the entire span of the second angle 200, increasing maximum allowable load and minimizing potential deformation issues.

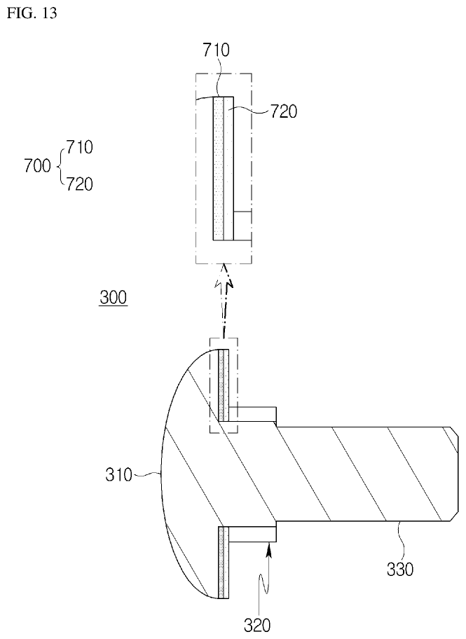

With reference to FIG. 13, the coupling member 300 includes a damper portion 700 to absorb the impact caused by friction with the first angle 100 or the second angle 200, when self-load or external force is applied, after being installed on one or both of the first and second angles 100 and 200.

For example, the damper portion 700 includes a first damper 710 that comes into surface-contact with the underside of the head portion 310 formed on the coupling member 300, and a second damper 720 that is integrally formed with the first damper 710 and comes into surface-contact with one or both of the first and second angles 100 and 200.

The first and second dampers 710 and 720 may be made of either ethylene propylene rubber (EPDM) or Teflon, both of which have elastic recovery properties, but the dampers are not limited to these materials.

As long as the first and second dampers 710 and 720 maintain elastic recovery, their ability to absorb energy from vibrations generated in the first and second angles 100 and 200 or transmitted impacts from external sources is enhanced.

The first and second dampers 710 and 720 maintain high elastic recovery, when made of the aforementioned materials, and the stiffness and vibration absorption capacity vary with the frequency of the applied force due to viscoelasticity. These characteristic changes, when the first and second angles 100 and 200 are assembled together through the coupling member 300, may enhance vibration absorption capability and resistance performance, which contributes to increased durability and enhances structural safety, allowing for safe long-term use with minimal checks and maintenance.

For example, the first damper 710 maintains a close contact with the underside of the head portion 310 and, when the coupling member 300 is installed, works in conjunction with the second damper 720 to induce elastic recovery, which helps prevent vibrations or friction between the first and second angles 100 and 200 and the coupling member 300.

In this case, the damper portion 700 can maintain a stable assembly state by preventing unnecessary noise and friction even when the first and second angles 100 and 200 are complexly assembled.

The damper portion 700 may be composed of the first damper 710 and the second damper 720 with different densities. In this case, the first and second dampers 710 and 720 can exhibit enhanced damping capabilities depending on the various frequencies of vibrations transmitted.

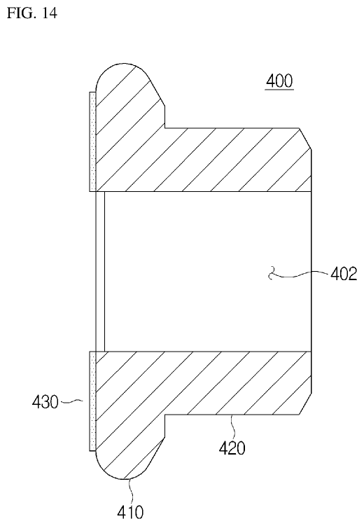

With reference to FIG. 14, the support member 400 according to this embodiment includes a nut head 410 formed with a predetermined diameter and a nut body 420 formed integrally with the nut head 410 and having a nut hole 402 formed in the axial direction of the coupling member 300 for insertion.

The support member 400 is provided to fix the coupling member 300 by being spiral-coupled with the shaft portion 330 with threads.

The support member 400 includes an auxiliary damper 430 formed on the front side of the nut head 410 and surface-contacting with a corresponding surface after being coupled with the coupling member 300.

The auxiliary damper 430 is adhered to the surface of the first angle 100 or the second angle 200 facing the front of the nut head 410 and serves the same role as the damper portion 700 to dampen vibrations generated in the first and second angles 100 and 200.

### Industrial Applicability

This embodiment is applicable to the industries where angles or angle assemblies are used to stably support heavy loads.

1. An angle assembly system comprising:
a first angle comprising a first coupling portion formed on the inner side of a first insertion hole arranged along the longitudinal direction;
a second angle comprising a second coupling portion formed on the inner side of a second insertion hole arranged along the longitudinal direction in a surface-contacted state to one end or an arbitrary position of the first angle;
a coupling member installed on the first and second angles in a state of being coupled to the first and second coupling portions; and
a support member coupled in the axial direction of the coupling member.

2. The angle assembly system of claim 1, wherein the coupling member comprises:
a head portion formed with a predetermined diameter;
a coupling tooth-shaped portion protruding from the underside of the head portion to have a predetermined thickness for engagement coupling with the first coupling portion or the second coupling portion; and
a shaft portion extending outwardly from the coupling tooth-shaped portion with a predetermined length and having threads formed on the outer side in the axial direction.

3. The angle assembly system of claim 2, wherein the coupling tooth-shaped-portion comprises:
a first coupling tooth-shaped-portion formed in the horizontal direction; and
a second coupling tooth-shaped-portion formed in the vertical direction.

4. The angle assembly system of claim 1, wherein the coupling tooth-shaped-portion extends in in both horizontal and vertical directions to a length corresponding to the width of the first and second coupling portions.

5. The angle assembly system of claim 1, wherein the first coupling portion comprises a first insertion hole extending for a predetermined length in the entire inner regions facing each other, and the second coupling portion comprises a second insertion hole extending for a predetermined length in the entire inner regions facing each other, the first coupling portion having a first tooth-shaped portion for engagement coupling with the coupling member, and the second coupling portion having a second tooth-shaped portion for engagement coupling with the coupling member.

6. The angle assembly system of claim 1, further comprising a reinforcing rib installed on one or both of the first and second angles at predetermined intervals along the inner length direction.

7. The angle assembly system of claim 6, wherein the reinforcing rib is inserted into insertion slots formed on the inner sides of the first and second angles and fixed through welding.

8. The angle assembly system of claim 1, further comprising a main rib arranged on one or both of the first and second angles at predetermined intervals along the inner length direction and coupled with the coupling member in different directions.

9. The angle assembly system of claim 8, wherein the main rib comprises:
a first rib designed to adhere to either or both of the bent inner surfaces of the first angle or the second angle and having a first rib coupling portion formed to engage with one coupling member inserted;
a second rib formed to adhere to the other bent inner surface of the first or second angles and having a second rib coupling portion formed to engage with another coupling member inserted; and
a third rib connecting the first and second ribs to each other.

10. The angle assembly system of claim 9, wherein the first rib coupling portion comprises a first rib coupling tooth-shaped portion formed on the inner side for engagement coupling with one coupling member, and the second rib coupling portion comprises a second rib coupling tooth-shaped portion formed on the inner side for engagement coupling with another coupling member.

11. An angle assembly system comprising:
a first angle comprising a first coupling portion formed on the inner side of a first insertion hole arranged along the longitudinal direction;
a second angle comprising a second coupling portion formed on the inner side of a second insertion hole arranged along the longitudinal direction in a surface-contacted state to one end or an arbitrary position of the first angle;
a coupling member installed on the first and second angles in a state of being coupled to the first and second coupling portions;
a support member coupled in the axial direction of the coupling member;
a main rib arranged on one or both of the first and second angles at predetermined intervals along the inner length direction and coupled with the coupling member in different directions; and
a damping member inserted into the coupling member and in surface-contact with one or both of the first and second angles to absorb impact.

12. The angle assembly system of claim 11, wherein the main rib comprises:
a first rib designed to adhere to one of the bent inner surfaces of the first angle or the second angle and has a first rib coupling portion formed to engage with a coupling member inserted;
a second rib designed to adhere to the other bent inner surface of the first angle or the second angle and has a second rib coupling portion formed to engage with another coupling member inserted;
and a third rib connecting the first and second ribs to each other.

13. The angle assembly system of claim 12, wherein the first rib coupling portion comprises a first rib coupling tooth-shaped portion formed on the inner side for engagement coupling with one coupling member, and the second rib coupling portion comprises a second rib coupling tooth-shaped portion formed on the inner side for engagement coupling with another coupling member.

14. The angle assembly system of claim 12, wherein the damping member comprises:
a first damper surface-contacting the underside of a head portion formed on the coupling member; and
a second damper integrally formed with the first damper and surface-contacting one or both of the first and second angles.
